(19) United States
(12) Patent Application Publication
(10) Pub. No.: US 2007/0024170 A1
(43) Pub. Date: Feb. 1, 2007

(54) Vacuum envelope and electron emission display device including the same

(76) Inventors: Jung-Ho Kang, Yongin-si (KR); Hyoung-Cheol Seo, Yongin-si (KR); Seung-Joon Yoo, Yongin-si (KR); Sung-Hwan Jin, Yongin-si (KR); Eung-Joon Chi, Yongin-si (KR)

Correspondence Address: CHRISTIE, PARKER & HALE, LLP, PO BOX 7068, PASADENA, CA, 91109-7068, US

(21) Appl. No.: 11/489,791

(22) Filed: Jul. 19, 2006

(30) Foreign Application Priority Data
Jul. 26, 2005 (KR) 10-2005-0068001
Apr. 21, 2006 (KR) 10-2006-0036120

(51) Int. Cl. H01J 19/42; H01J 63/04

(52) U.S. Cl. 313/257; 313/495

(57) ABSTRACT

An electron emission display device includes first and second substrates facing each other, an electron emission unit located on the first substrate, and a light emission unit located on the second substrate to emit visible light in response to electrons emitted from the electron emission unit. Spacers are arranged between the first and second substrates. First support members are formed on the first substrate or the second substrate and are spaced apart from the spacers.

### CROSS-REFERENCES TO RELATED APPLICATIONS

This application claims priority to and the benefit of Korean Patent Application Nos. 10-2005-0068001 and 10-2006-0036120 filed on Jul. 26, 2005 and Apr. 21, 2006, respectively, in the Korean Intellectual Property Office, the entire contents of both of which are incorporated herein by reference.

### BACKGROUND OF THE INVENTION

1. Field of the Invention

The present invention relates to an electron emission display device, and in particular, to a support structure for spacers arranged within a vacuum envelope.

2. Description of Related Art

An electron emission display device typically includes first and second substrates forming a vacuum envelope, and electron emission regions formed on the first substrate together with driving electrodes for controlling the emission of electrons from those electron emission regions. Phosphor layers are formed on the second substrate together with an anode electrode for effectively accelerating the electrons emitted from the first substrate side toward the phosphor layers. With this structure, the electron emission display device emits light, or displays desired images.

A plurality of spacers are provided within the vacuum envelope of the electron emission display device. The spacers maintain the distance between the first and second substrates in a constant manner, and prevent the substrates from being deformed and broken due to the inner and outer pressure difference of the vacuum envelope. The spacers are typically attached to the top of the structure of the first substrate or to the top of the structure of the second substrate using an adhesive film.

However, with the attachment structure of the spacers based on the adhesive film, the adhesion of the spacers to the substrate is very weak such that some of the spacers can be tilted or fall off. Consequently, it may become difficult to uniformly withstand the pressure applied to the vacuum envelope, and the tilted spacers may block the trajectories of electron beams, thereby deteriorating the display characteristic.

Further, when wall-type spacers are used, these spacers can expand and bend due to heat during sealing and firing processes so that they do not proceed linearly.

### SUMMARY OF THE INVENTION

It is an aspect of the present invention to provide a vacuum envelope that solidly fixes the spacers without using an adhesive film and prevents the spacers from being bent, and an electron emission display device with the vacuum envelope.

This and other aspects may be achieved by an electron emission display device with the following features.

According to one aspect of the present invention, an electron emission display device includes first and second substrates facing each other, an electron emission unit located on the first substrate and adapted to emit electrons, and a light emission unit located on the second substrate and adapted to emit visible light in response to the electrons emitted from the electron emission unit. Spacers are located between the first and second substrates. Support members are located on the first substrate or the second substrate and are spaced apart from the spacers.

A plurality of the support members may be arranged along a longitudinal direction of each spacer with a predetermined distance therebetween.

A longitudinal direction of each support member may be substantially perpendicular to the longitudinal direction of each spacer.

The support members on opposite sides of each spacer may face each other.

The support members on opposite sides of each spacer may be offset from each other.

The electron emission display device may further include second support members tightly adhered to corresponding said spacers. The support members and the second support members may be alternately arranged along a longitudinal direction of each spacer.

The support members and the second support members on opposite sides of each spacer may face each other.

Each support member may include first supports spaced apart from the spacer in parallel to a longitudinal direction of the spacers, and second supports connected to the first supports and perpendicular to the first supports.

The second supports on opposite sides of each spacer may face each other.

The first supports on opposite sides of each spacer may face each other, and the second supports may be arranged along the longitudinal direction of each spacer, and the second supports on opposite sides of each spacer may be offset from each other.

The first and second supports on opposite sides of the respective spacers may face each other, and the second supports may be connected to the first supports neighboring each other.

Each support member may have a height of about 20-200 μm.

The distance between the support member and the spacer may be about 20 μm or less.

The electron emission unit may include cathode and gate electrodes crossing each other on the first substrate with an insulating layer interposed therebetween, and electron emission regions connected to the cathode electrodes. The spacers may be arranged between one of the cathode electrodes or the gate electrodes parallel thereto, and the support members may be arranged between the other one of the cathode electrodes and the gate electrodes parallel thereto.

The electron emission unit may include cathode and gate electrodes crossing each other on the first substrate with an insulating layer interposed therebetween, and electron emission regions connected to the cathode electrodes. The spacers and the first supports may be arranged between one of the cathode electrodes or the gate electrodes parallel thereto, and the second supports may be arranged between the other one of the cathode electrodes or the gate electrodes parallel thereto.

The support members and the spacers may be formed with the same material.

When the distance between the support member and the second support members is indicated by A, and the thickness of the spacer is indicated by S, the distance A may satisfy the condition S<A<S+40 μm.

When the distance between the second support members is indicated by L, and the thickness of the spacer is indicated by S, the distance L may satisfy the condition S−10 μm<L<S+10 μm.

According to another aspect of the present invention, a vacuum envelope includes a first substrate, a second substrate facing the first substrate, spacers located between the first and second substrates, and support members located on the first substrate or the second substrate and spaced apart from the spacers.

### BRIEF DESCRIPTION OF THE DRAWINGS

FIG. 1 is a partial exploded perspective view of an electron emission display device according to a first embodiment of the present invention.

FIG. 2 is a partial plan view of a spacer and support members shown in FIG. 1.

FIG. 3 is a partial exploded perspective view of an electron emission display device according to a second embodiment of the present invention.

FIG. 4 is a partial plan view of a spacer and support members shown in FIG. 3.

FIGS. 5 to 8 are partial plan views that illustrate variations of the support members in accordance with other embodiments.

### DETAILED DESCRIPTION

With reference to the accompanying drawings, exemplary embodiments of the present invention will be described in order for those skilled in the art to be able to implement them. As those skilled in the art would realize, the described embodiments may be modified in various different ways, all without departing from the spirit or scope of the present invention. Wherever possible, the same reference numbers will be used throughout the drawing(s) to refer to the same or like parts.

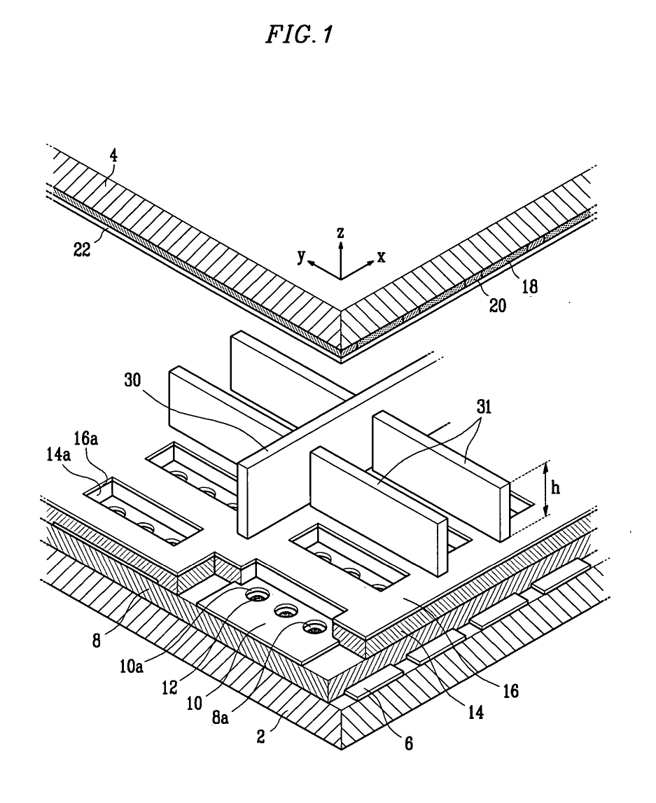

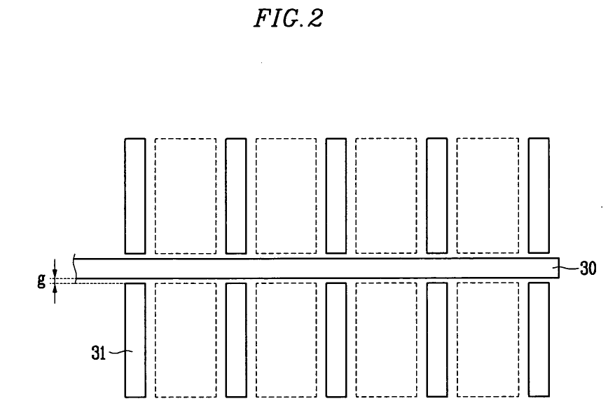

FIG. 1 is a partial exploded perspective view of an electron emission display device according to a first embodiment of the present invention, and FIG. 2 is a partial plan view of a spacer and support members shown in FIG. 1.

As shown in FIG. 1, the electron emission display device according to the first embodiment includes first and second substrates 2 and 4 facing each other in parallel with a predetermined distance therebetween. One or more side members (not shown) are provided at the peripheries of the first and second substrates 2 and 4 to form a vacuum envelope together with the substrates 2 and 4.

An electron emission unit is provided at the first substrate 2 to emit electrons, and a light emission unit is provided at the second substrate 4 to emit visible rays in response to the electrons.

Concerning the electron emission unit, cathode electrodes 6 are stripe-patterned on the first substrate 2 and extend in a first direction (in the y axis direction of FIG. 1), and a first insulating layer 8 is formed on substantially the entire surface of the first substrate 2 such that it substantially covers all the cathode electrodes 6. Gate electrodes 10 are stripe-patterned on the first insulating layer 8 perpendicular to the cathode electrodes 6 (in the x axis direction of FIG. 1).

In this embodiment, when the crossed regions of the cathode and gate electrodes 6 and 10 are defined as pixels, one or more electron emission regions 12 are formed on the cathode electrodes 6 at the respective pixels. Opening portions 8a and 10a are respectively formed at the first insulating layer 8 and the gate electrodes 10 corresponding to the respective electron emission regions 12 to expose the electron emission regions 12 on the first substrate 2.

FIG. 1 shows that the electron emission regions 12 are formed in the shape of a circle, and are linearly arranged in the longitudinal direction of the cathode electrodes 6 at the respective pixels. However, the plane shape, number per pixel, and arrangement of the electron emission regions 12 are not limited to those illustrated in FIG. 1.

The electron emission regions 12 are formed with a material for emitting electrons when an electric field is applied thereto under a vacuum condition. Such material for emitting electrons may include a carbonaceous material or a nanometer-sized material. In one embodiment, the electron emission regions 12 are formed with carbon nanotubes, graphite, graphite nanofiber, diamond, diamond-like carbon, fullerene (C₆₀), silicon nanowire, or a combination thereof.

A second insulating layer 14 and a focusing electrode 16 are formed on the gate electrodes 10 and the first insulating layer 8. Opening portions 14a and 16a are respectively formed at the second insulating layer 14 and the focusing electrode 16 to expose the electron emission regions 12 on the first substrate 2. The opening portions 14a and 16a are individually provided at the respective pixels such that the focusing electrode 16 can collectively focus the electrons emitted from each pixel.

In one embodiment described above, the gate electrodes 10 are placed over the cathode electrodes 6 while interposing the first insulating layer 8. In other embodiments, the gate electrodes may be placed under the cathode electrodes. In the latter case, the electron emission regions contact one surface of the cathode electrodes and can be formed on the first insulating layer.

Regarding the light emission unit, phosphor layers 18 are formed on a surface of the second substrate 4 facing the first substrate 2 together with a black layer 20 for enhancing the screen contrast. An anode electrode 22 is formed on the phosphor layers 18 and the black layer 20 with a metallic material such as aluminum. The anode electrode 22 receives a high voltage required for accelerating electron beams from the outside, and reflects the visible rays radiated from the phosphor layers 18 in the direction of the first substrate 2 toward the second substrate 4, thereby increasing the screen brightness.

The anode electrode may be formed with a transparent material such as indium tin oxide (ITO), instead of the metallic material. In this case, the anode electrode is placed on a surface of the phosphor and the black layers directed toward the second substrate.

A plurality of wall spacers 30 are provided between the first and second substrates 2 and 4 to maintain a predetermined distance therebetween. The spacers 30 may be arranged between the cathode electrodes in parallel therewith, or between the gate electrodes 10 in parallel therewith. The latter case is illustrated in FIG. 1.

When the area where the electron emission unit and the light emission unit are provided at the first and second substrates to substantially cause the display is defined as an effective area, the spacers may transverse substantially the entire effective area in the long axis or short axis direction of the first and second substrates.

A plurality of first support members (or support members) 31 are formed at the lateral sides of each spacer 30 to support it. The support members 31 are arranged along the longitudinal direction of the spacer 30 (in the x axis direction of the drawing) with a predetermined distance therebetween. By way of example, as shown in FIG. 2, the first support members 31 may be arranged perpendicular to the longitudinal direction of the spacer 30. It is illustrated in FIG. 1 that the spacers 30 proceed (or extend) in parallel to the gate electrodes 10, and the first support members 31 proceed (or extend) in parallel to the cathode electrodes 6. In other embodiments, the spacers may proceed in parallel to the cathode electrodes 6, and the first support members 31 may proceed in parallel to the gate electrodes 10.

In the embodiment illustrated in FIGS. 1 and 2, the spacers 30 are arranged in parallel, where each spacer 30 is located between two adjacent gate electrodes 10. Each row of first support members 31 is located between two neighboring spacers 30. The first support members 31 face (or are substantially aligned with) each other in a one-to-one relationship with the spacer 30 interposed between them.

The first support members 31 are spaced apart from each spacer 30 by a distance g, which may be predetermined, at both lateral sides of the spacer 30. The distance g may be substantially constant along the longitudinal direction of the spacer 30. In the case where the distance g is too large, the support members 31 may not function properly so that the spacer 30 may be tilted. Accordingly, in one embodiment, the distance g is about 20 μm or less.

Furthermore, the height h of the first support members 31 may be established to be about 20-200 μm. When the height h of the first support members 31 is less than 20 μm, the first support members 31 may not support the spacer 30 properly so that the spacer 30 may fall over. On the other hand, when the height of the first support members 31 exceeds 200 μm, it becomes difficult to form them. The first support members 31 are formed by first coating a paste onto the structure of the first substrate or the second substrate such that the coated paste has a thickness (i.e., height) of 20-200 μm, which may be predetermined, and then by patterning the coated paste. When the thickness (i.e., height) of the coated paste exceeds 200 μm, it typically becomes difficult to form the first support members with a precise shape.

The first support members 31 may be formed with a material having elasticity or a thermal expansion coefficient identical with or similar to that of the spacers 30. For instance, the first support member 31 may be formed with glass or ceramic.

In the described embodiment, the electron emission display device has a focusing electrode 16, but the first support members may also be applied to the electron emission display device that do not include the focusing electrode 16. In this case, the first support members are disposed between the cathode electrodes. The first support members 31 may be formed on the second substrate 4 as well as on the first substrate 2. In this case, the first support members 31 are formed on the anode electrode 22 between the phosphor layers 18. The dotted lines of FIG. 2 indicate the locations of the phosphor layers 18.

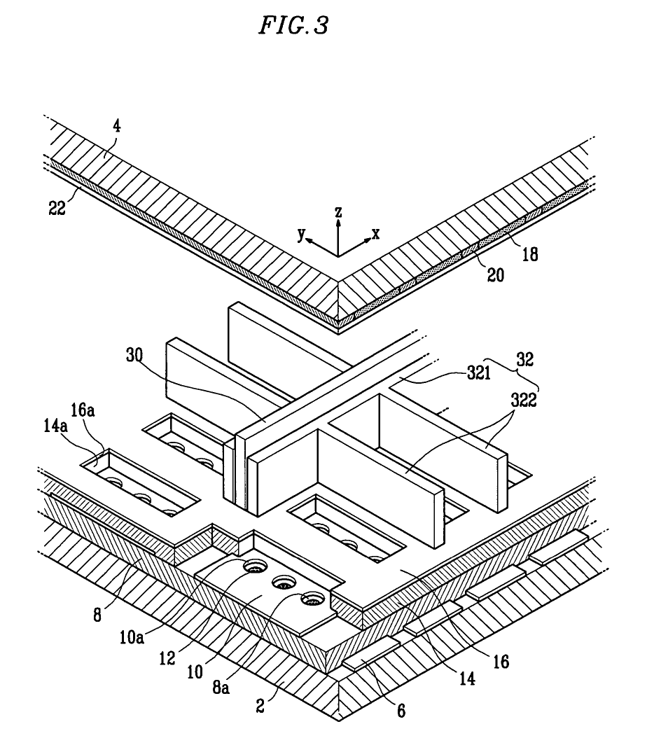

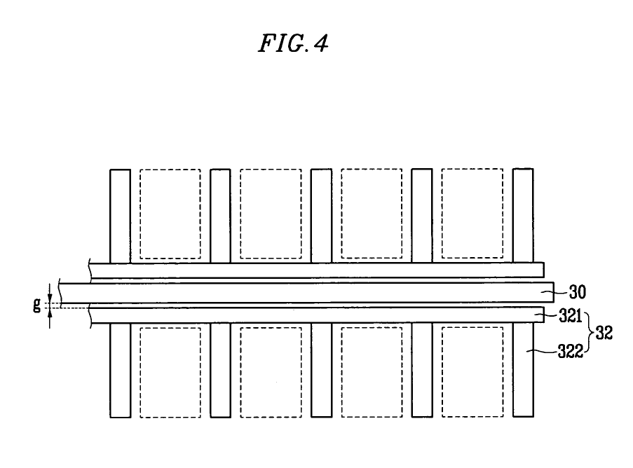

FIG. 3 is a partial exploded perspective view of an electron emission display device according to a second embodiment of the present invention, and FIG. 4 is a partial plan view of a spacer and support members shown in FIG. 3. As shown in FIGS. 3 and 4, the electron emission display device according to the second embodiment is substantially the same as that of the first embodiment except for the first support members.

First support members 32 of the electron emission display device according to the second embodiment of the present invention each have a first support 321 proceeding (or extending) in the longitudinal direction of the spacer 30, and a plurality of second supports 322 connected (or attached) to the first support 321 and are perpendicular thereto. The distance g between the first support 321 and the spacer 30, and the height h thereof, are the same as those described above in reference to the first embodiment. Further, as shown in FIG. 3, the second support 322 in the second embodiment are disposed between the cathode electrodes 6 and are parallel thereto.

Furthermore, the plurality of second supports 322 are spaced apart from each other by a distance, which may be predetermined, to reinforce the first support 321. The height of the second supports 322 may be the same as that of the first support 321, or it may be any other suitable height different from that of the first support 321.

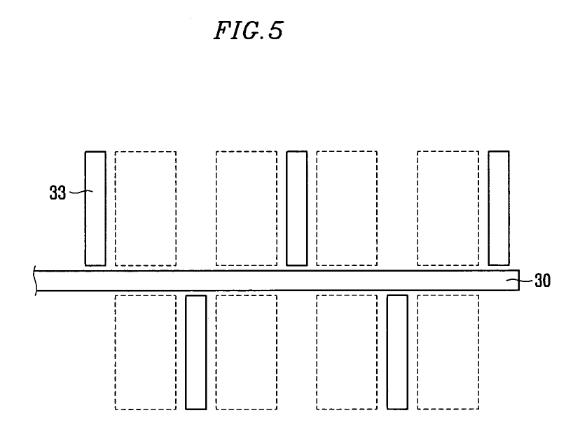

FIGS. 5 to 8 are partial plan views of variants of the support members in accordance with other embodiments.

As shown in FIG. 5, the first support members (or support members) 33 are arranged at both lateral sides of the spacer 30 with a distance, which may be predetermined, along the longitudinal direction of the spacer 30, and are offset from each other. In other words, the first support members 33 on opposite sides of the spacer 30 do not face (i.e., are not aligned with) each other.

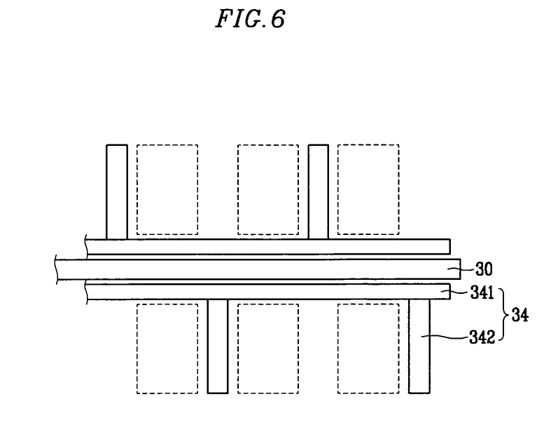

As shown in FIG. 6, the first support members (or support members) 34 include first supports 341 placed at both sides of the spacer 30, and second supports 342 connected (or attached) to the first supports 341 perpendicularly thereto in a manner that they are offset from each other. In other words, the second supports 342 on opposite sides of the spacer 30 do not face (i.e., are not aligned with) each other.

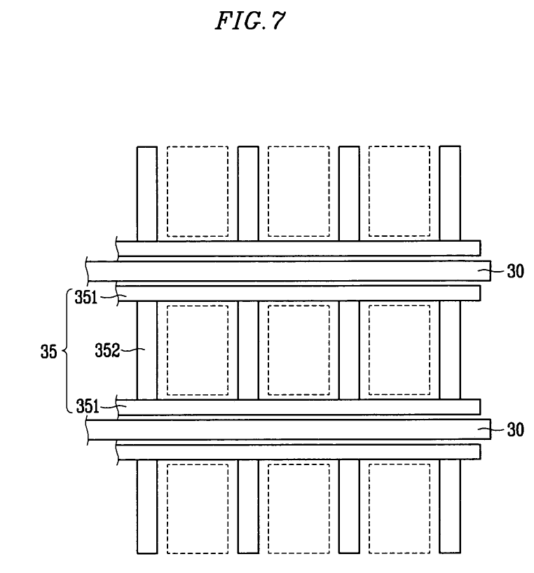

As shown in FIG. 7, the first support member (or support member) 35 may be formed in the shape of a ladder such that a plurality of second supports 352 interconnect a pair of first supports 351 neighboring each other.

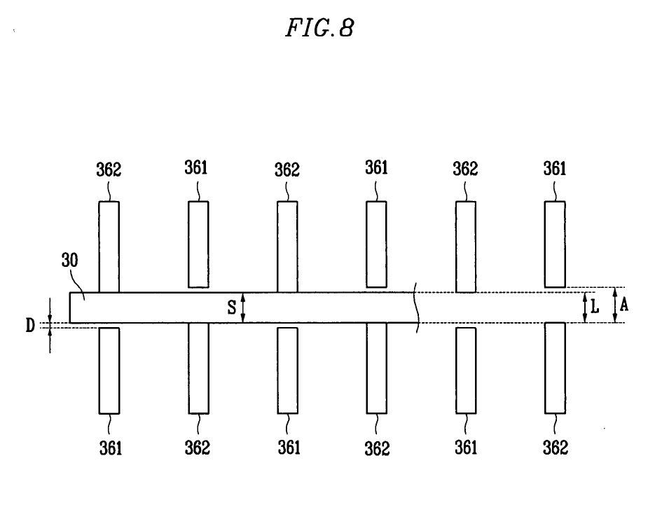

As shown in FIG. 8, an electron emission display device according to an embodiment of the present invention includes first support members (or support members) 361 that are spaced apart from the spacer 30 by a predetermined distance of D, and second support members 362 that are tightly adhered to the spacer 30. The two kinds of support members 361 and 362 are arranged in the longitudinal direction of the spacer 30 at substantially regular intervals. For instance, the first and second support members 361 and 362 are alternately arranged in the longitudinal direction of the spacer 30 in the embodiment shown in FIG. 8.

Furthermore, as shown in FIG. 8, the distance A between the first and second support members 361 and 362 that face (or are substantially aligned with) each other with the spacer 30 interposed therebetween in the described embodiment, is set to be greater than the thickness S of the spacer 30 and smaller than 40 μm added to the thickness S of the spacer 30. That is, S<A<S+40 μm.

When the distance A is smaller than the thickness S of the spacer, it is difficult to fit the spacer between the support members. On the other hand, when the distance A is greater than 40 μm added to the thickness S, it is difficult to support the spacer.

In order for the second support members 362 to effectively pressurize and support the spacer 30, the distance L between the second support members 362 placed at opposite sides of the spacer 30 in the described embodiment is set to be greater than 10 μm subtracted from the thickness S of the spacer and smaller than 10 μm added to the thickness S of the spacer. That is, S−10 μm<L<S+10 μm. However, in case the distance L is smaller than the thickness S, the second support members 362 may have elasticity to arrange the spacer 30 therebetween.

When the distance L is smaller than 10 μm subtracted from the thickness S of the spacer, the pressure applied to the spacer 30 due to the second support members 362 is so high that the spacer or the second support members 362 may be damaged. Furthermore, when the distance L is greater than 10 μm added to the thickness S of the spacer, it is difficult to solidly support the spacer.

As the first support member 361 and the spacer 30 are spaced apart from each other by a distance D, the expansion of the spacer 30 is compensated for by the distance D. Consequently, with the electron emission display device according to the present embodiment, a collision between the spacer 30 and the first support member 361 due to the expansion of the spacer 30 and the deformation thereof can be prevented.

It is shown in FIG. 8 that the first and second support members 361 and 362 are arranged at substantially regular intervals in the longitudinal direction of the spacer 30, but they may be arranged at irregular intervals in other embodiments.

The embodiments of the present invention have been described herein in reference to a field emitter array (FEA) type of electron emission display device where the electron emission regions are formed with a material for emitting electrons under the application of an electric field. However, the inventive structure is not limited to the FEA type, but may be easily applied to other electron emission display devices. Furthermore, the inventive structure may be applied to any devices with a vacuum envelope mounting spacers therein as well as the electron emission display devices.

As described above, with an electron emission display device according to an embodiment of the present invention, support members are provided at the lateral sides of the spacer to support it, and the spacer is substantially prevented from being tilted or falling. Furthermore, with the installation of the spacers, the support members have a role of guiding the locations of the spacers to make the spacer installation easy, and substantially prevent the spacers from being bent or deformed.

Although certain exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims and their equivalents.

What is claimed is:

1. An electron emission display device comprising:
a first substrate;
a second substrate facing the first substrate;
an electron emission unit located on the first substrate and adapted to emit electrons;
a light emission unit located on the second substrate and adapted to emit visible light in response to the electrons emitted from the electron emission unit;
spacers located between the first and second substrates; and
support members located on the first substrate or the second substrate and spaced apart from the spacers.

2. The electron emission display device of claim 1, wherein a plurality of the support members are arranged along a longitudinal direction of each spacer with a predetermined distance therebetween.

3. The electron emission display device of claim 2, wherein a longitudinal direction of the support members is substantially perpendicular to the longitudinal direction of each spacer.

4. The electron emission display device of claim 2, wherein the support members on opposite sides of each spacer face each other.

5. The electron emission display device of claim 2, wherein the support members on opposite sides of each spacer are offset from each other.

6. The electron emission display device of claim 1, further comprising second support members tightly adhered to corresponding said spacers, wherein the support members and the second support members are alternately arranged along a longitudinal direction of each spacer.

7. The electron emission display device of claim 6, wherein the support members and the second support members on opposite sides of each spacer face each other.

8. The electron emission display device of claim 1, wherein the support members comprise first supports spaced apart from each spacer in parallel to a longitudinal direction of the spacers, and second supports connected to the first supports and are perpendicular to the first supports.

9. The electron emission display device of claim 8, wherein the second supports on opposite sides of each spacer face each other.

10. The electron emission display device of claim 8, wherein the first supports on opposite sides of each spacer face each other, and the second supports are arranged along the longitudinal direction of each spacer, and the second supports on opposite sides of each spacer are offset from each other.

11. The electron emission display device of claim 8, wherein the first and second supports on opposite sides of the respective spacers face each other, and the second supports are connected to the first supports neighboring each other.

12. The electron emission display device of claim 1, wherein each support member has a height of about 20-200 μm.

13. The electron emission display device of claim 1, wherein the distance between the support members and a corresponding one of the spacers is about 20 μm or less.

14. The electron emission display device of claim 1, wherein the electron emission unit comprises cathode and gate electrodes crossing each other on the first substrate with an insulating layer interposed therebetween, and electron emission regions connected to the cathode electrodes, wherein the spacers are arranged between one of the cathode electrodes or the gate electrodes parallel thereto, and the support members are arranged between the other one of the cathode electrodes or the gate electrodes parallel thereto.

15. The electron emission display device of claim 8, wherein the electron emission unit comprises cathode and gate electrodes crossing each other on the first substrate with an insulating layer interposed therebetween, and electron emission regions connected to the cathode electrodes, wherein the spacers and the first supports are arranged between one of the cathode electrodes or the gate electrodes parallel thereto, and the second supports are arranged between the other one of the cathode electrodes or the gate electrodes parallel thereto.

16. The electron emission display device of claim 1, wherein the support members and the spacers are formed with the same material.

17. The electron emission display device of claim 7, wherein when the distance between the support member and the second support members is indicated by A, and the thickness of the spacer is indicated by S, the distance A satisfies the condition: S<A<S+40 μm.

18. The electron emission display device of claim 7, wherein when the distance between the second support members is indicated by L, and the thickness of the spacer is indicated by S, the distance L satisfies the condition: S−10 μm<L<S+10 μm.

19. A vacuum envelope comprising:
a first substrate;
a second substrate facing the first substrate;
spacers located between the first and second substrates; and
support members located on the first substrate or the second substrate and spaced apart from the spacers.

20. The vacuum envelope of claim 19, wherein a plurality of the support members are arranged along a longitudinal direction of each spacer with a predetermined distance therebetween.

21. The vacuum envelope of claim 20, wherein the support members on opposite sides of each spacer face each other.

22. The vacuum envelope of claim 19, wherein the support members on opposite sides of each spacer are offset from each other.

23. The vacuum envelope of claim 19, further comprising second support members tightly adhered to corresponding said spacers.
